(19) United States
(12) Patent Application Publication
(10) Pub. No.: US 2022/0071391 A1
(43) Pub. Date: Mar. 10, 2022

(54) HIGH STRUCTURAL STRENGTH DISPLAY STAND WITH BENDING TUBES

(71) Applicant: Wensonic Technology CO., Ltd., New Taipei City (TW)

(72) Inventor: Chih-Sheng Huang, New Taipei City (TW)

(21) Appl. No.: 17/012,064

(22) Filed: Sep. 4, 2020

(51) Int. Cl. A47B 81/06; F16M 11/42

(52) U.S. Cl. CPC A47B 81/06; F16M 11/42

(57) ABSTRACT

The present invention relates to a high structural strength display stand with bending tubes. The display stand includes a lower supporting unit, an upper supporting unit and a foot rack. The lower supporting unit has a plurality of lower supports, each of which comprises a first and a second bending section spaced from each other. The upper supporting unit has a plurality of upper supports, each of which comprises a third and a fourth bending section spaced from each other. The foot rack is arranged adjacent to the lower supporting unit and assembled to the lower supports, such that the foot rack and the lower supports are juxtaposed.

### FIELD OF THE INVENTION

The present invention relates to a display stand, and more particularly, to a display stand with bending tubes having highly increased weight load capacity and enhanced overall structural strength.

### BACKGROUND OF THE INVENTION

Due to the progress in the display manufacturing techniques, many electronic products, such as video displays and interactive whiteboards, not only become bigger and bigger in size, but also becomes much heavier than before. Therefore, it is an important task for the display related manufacturers to develop a mounting device strong enough for mounting the big-size display.

Presently, the display mounting devices can be generally divided into two types, i.e. a wall-mount type and a mobile-stand type. The mounting devices of the wall-mount type are usually applied to general displays such as television display, which do not need to be moved and are frequently fixed on a wall, and this type of mounting devices has a simple structure.

On the other hand, the mounting devices of the mobile-stand type are designed to move freely to meet actual need in use and can provide high flexibility in use. However, the supporting strength of the mounting devices of the mobile-stand type display must pass the authentication tests certified by relevant organizations, such as Underwriters Laboratories Inc (UL), in order to ensure the safety of use.

Most of the currently available mobile-stand type display mounting devices are assembled from square tubes or round tubes which are connected to one another by welding. Such a manufacturing process is cumbersome and the manufacturing time is long. After the welding, the surface with weld seams must be polished, which inevitably reduces the overall structural strength of the supporting tubes.

In view of the above drawbacks, display related manufacturers are desired to develop a high structural strength display stand which is improved compared to the conventional display mounting devices and can be more simply manufactured with less process time.

### SUMMARY OF THE INVENTION

To solve the problems of the conventional display mounting devices, a primary object of the present invention is to provide a high structural strength display stand with bending tubes which has high weight load capacity.

Another object of the present invention is to provide a display stand with bending tubes that has significantly enhanced overall structural strength.

A further object of the present invention is to provide a high structural strength display stand with bending tubes, which involves greatly simplified manufacturing processes and requires less manufacturing time.

To achieve the above and other objects, the high structural strength display stand with bending tubes according to a preferred embodiment of the present invention includes a lower supporting unit, an upper supporting unit and a foot rack. The lower supporting unit has a plurality of lower supports, each of which comprises a first and a second bending section spaced from each other. The upper supporting unit has a plurality of upper supports, each of which comprises a third and a fourth bending section spaced from each other. The foot rack is arranged adjacent to the lower supporting unit and assembled to the lower supports, such that the foot rack and the lower supports are juxtaposed.

With the first and second bending sections on the lower supporting unit, the third and the fourth bending sections on the upper supporting unit, and the fifth and sixth bending sections on the foot rack, the display stand of the present invention is capable to support a display unit up to 400 Kgs (follow UL1678 standard). The display stand with bending tubes not only has enhanced structural strength and highly increased weight load capacity, but also possesses the advantages of significantly simplified manufacturing processes and less processing time.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein:

FIG. 1 is a front exploded perspective view of a high structural strength display stand with bending tubes according to a preferred embodiment of the present invention;

FIG. 2 is an exploded perspective view of FIG. 1 from another angle;

FIG. 3 is an exploded perspective view of a lower part of the display stand according to the preferred embodiment of the present invention;

FIG. 4 is a front assembled perspective view of the display stand according to the preferred embodiment of the present invention; and

FIG. 5 shows the display stand of the present invention with a display unit mounted thereon.

### DETAILED DESCRIPTION OF THE PREFERRED EMBODIMENTS

The present invention will now be described with a preferred embodiment thereof and by referring to the accompanying drawings.

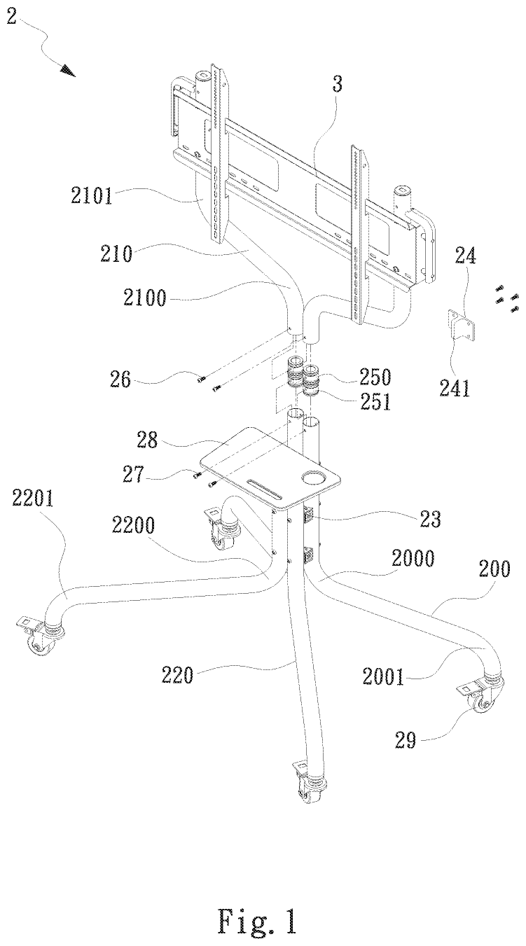

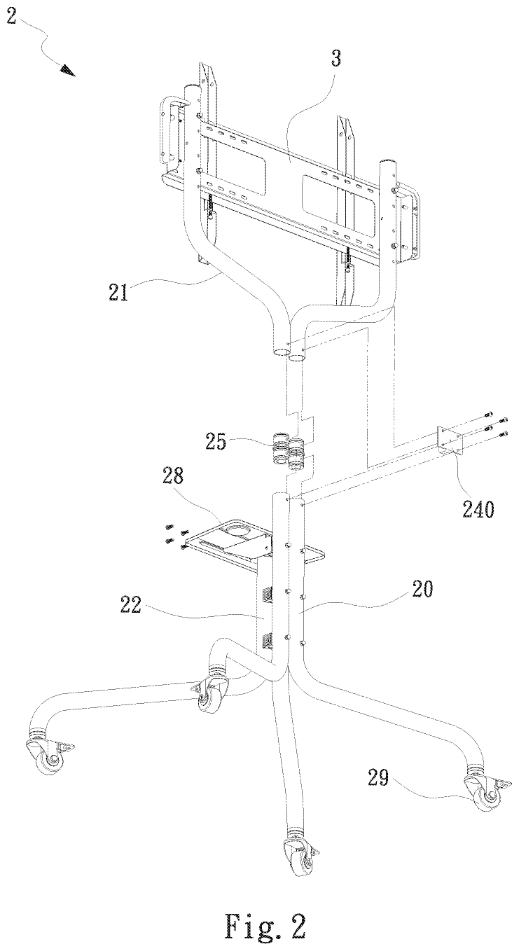

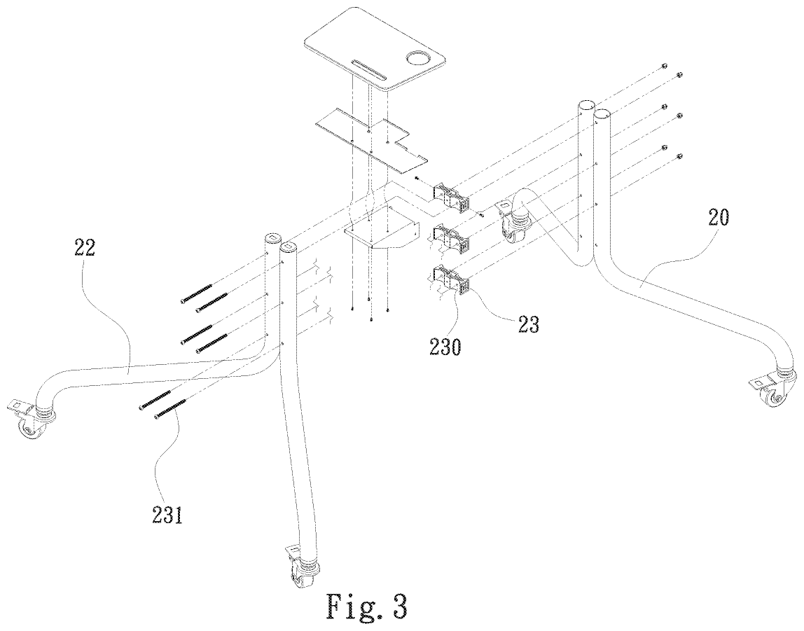

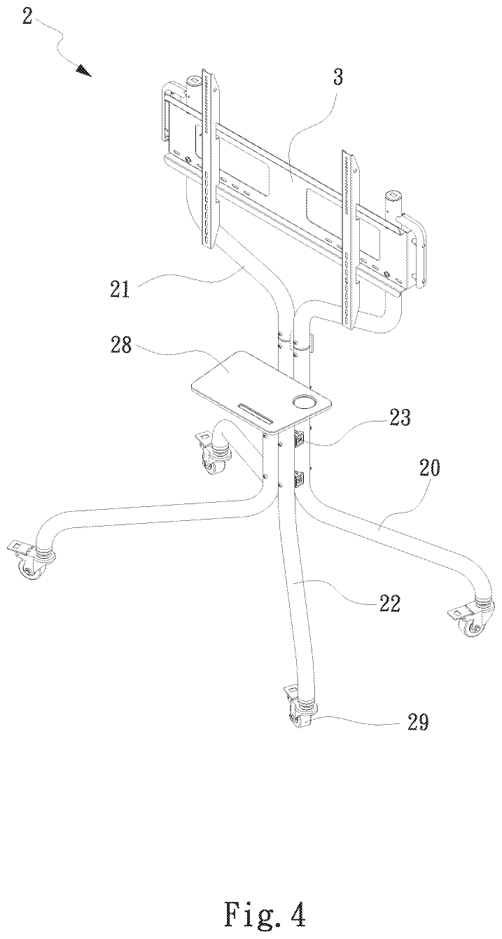

Please refer to FIGS. 1 to 4, which are exploded and assembled perspective views showing a high structural strength display stand with bending tubes according to a preferred embodiment of the present invention. For the purpose of conciseness and clarity, the present invention is briefly referred to as the display stand and denoted by reference numeral 2 herein. As shown, the display stand 2 includes a lower supporting unit 20, an upper supporting unit 21 and a foot rack 22. The lower supporting unit 20 comprises a plurality of tubular lower supports 200. In the illustrated preferred embodiment, two lower supports 200 are shown. However, in practical implementation of the present invention, the number of the lower supports 200 is not necessarily limited to two. Each of the lower supports 200 has a first bending section 2000 and a second bending section 2001. The lower support 200 extends from a vertical part to the first bending section 2000 and then extends in a substantially horizontal outward direction to the second bending section 2001, at where the lower support 200 extends downward, such that the second bending section 2001 is located away from the first bending section 2000 by a predetermined distance. Further, the two lower supports 200 are arranged in a way such that the two first bending sections 2000 are located side by side while the two second bending sections 2001 are located opposite to one another and directed towards two different directions.

The upper supporting unit 21 consists of a plurality of tubular upper supports 210. In the illustrated preferred embodiment, two upper supports 210 are shown. However, in practical implementation of the present invention, the number of the upper supports 210 is not necessarily limited to two. Each of the two upper supports 210 has a lower end correspondingly connected to an upper end of one of the lower supports 200; and each of the two upper supports 210 comprises a third bending section 2100 and a fourth bending section 2101. The upper support 210 upwardly extends from a vertical part to the third bending section 2100 and then extends in a substantially horizontal outward direction to the fourth bending section 2101, at where the upper support 210 extends upward, such that the fourth bending section 2101 is located away from the third bending section 2100 by a predetermined distance. Further, the two upper supports 210 are arranged in a way such that the two third bending sections 2100 are located side by side while the two fourth bending sections 2101 are located opposite to one another and directed towards two different directions.

It is noted the lower supporting unit 20 and the upper supporting unit 21 illustrated in the preferred embodiment of the present invention are not integrally formed. However, it is understood, in other operable embodiments, the lower and the upper supporting units 20, 21 can be otherwise integrally formed according to user's actual requirements.

According to the preferred embodiment, at least one connection unit 25 is internally provided at a joint of the lower supporting unit 20 and the upper supporting unit 21. The connection unit 25 has two ends that form an upper connection section 250 and a lower connection section 251. The upper connection section 250 is correspondingly connected to the upper supports 210 and fixed thereto by inserting a first fastening element 26 through the upper supports 210 and the upper connection section 250. The lower connection section 251 is correspondingly connected to the lower supports 200 and fixed thereto by inserting a second fastening element 27 through the lower supports 200 and the lower connection section 251.

A reinforcement unit 24 is externally provided at the joint of the lower supporting unit 20 and the upper supporting unit 21 corresponding to the connection unit 25. More specifically, the reinforcement unit 24 includes a flat locating plate 240 and a protruded section 241. When installing the reinforcement unit 24, the flat locating plate 240 is disposed away from the joint of the lower supports 200 and the upper supports 210, while the protruded section 241 is disposed in a clearance between the lower supports 200 and between the upper supports 210 at the joint of the lower supporting unit 200 and the upper supporting unit 210. In addition, the reinforcement unit 24 can further include a cable manager (not shown), with which a user can organize cords or cables.

The foot rack 22 comprises a plurality of tubular supporting legs 220. The supporting legs 220 are located adjacent to the lower supporting unit 20 and assembled to the lower supports 200, such that the supporting legs 220 and the lower supports 200 are juxtaposed. In the illustrated preferred embodiment, there are two supporting legs 220. However, in practical implementation of the present invention, the number of the supporting legs 220 is not necessarily limited to two. Each of the two supporting legs 220 has a fifth bending section 2200 and a sixth bending section 2201. The supporting leg 220 extends from a vertical part to the fifth bending section 2200 and then extends in a substantially horizontal outward direction to the sixth bending section 2201, at where the supporting leg 220 extends downward, such that the sixth bending section 2201 is located away from the fifth bending section 2200 by a predetermined distance. Further, the two supporting legs 220 are arranged in a way such that the two fifth bending sections 2200 are located side by side, while the two sixth bending sections 2201 are located opposite to one another and directed towards two different directions.

It is noted the lower supporting unit 20, the upper supporting unit 21 and the foot rack 22 in the illustrated preferred embodiment of the present invention are in the shape of a round tube. However, it is understood, in other operable embodiments, the lower supporting unit 20, the upper supporting unit 21 and the foot rack 22 can be tubes of any other cross-sectional shapes, such as oval shape or square shape, depending on actual need in use. Thus, other display stands 2 with other different cross-sectional tubes are also included in the protection scope of the present invention.

The high structural strength display stand with bending tubes according to the present invention further includes at least one locating unit 23. The locating unit 23 has two opposite sides, which are correspondingly provided with a plurality of recesses 230. More specifically, in the illustrated preferred embodiment, the recesses 230 are respectively semicircular in shape to match the round tubes of the two supporting legs 220 of the foot rack 22 and the two lower supports 200 of the lower supporting unit 20. With this arrangement, the locating unit 23 can be disposed in between the foot rack 22 and the lower supporting unit 20 with the semicircular recesses 230 fitly bearing against outer circumferential surfaces of the supporting legs 220 and the lower supports 200. At least one tightening elements 231 can be sequentially extended through the foot rack 22, the locating unit 23 and the lower supporting unit 20 to firmly fasten these components to one another and hold them in place. The locating unit 23 may further include a hanger (not shown) that provides an organizer function for holding things thereto orderly.

The display stand 2 also includes a table 28 mounted to an upper end of the foot rack 22 for conveniently storing or holding things thereon.

The display stand 2 further comprises a plurality of casters 29, which are separately assembled to lower ends of the lower supports 200 near the second bending sections 2001 and lower ends of the supporting legs 220 near the sixth bending sections 2201. With the casters 29, the display stand 2 can be freely moved by a user. It is understood the display stand 2 may be provided without the casters in other operable embodiments.

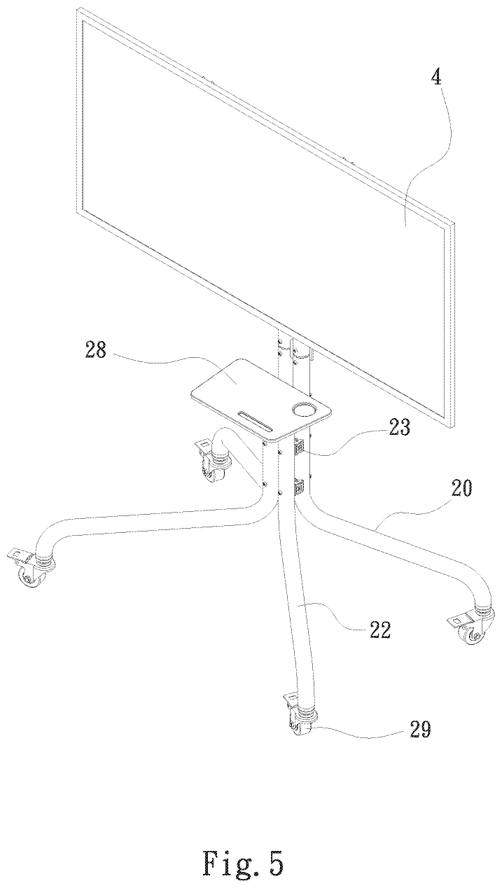

The display stand 2 also includes a mounting unit 3, which has two lateral ends separately assembled to the two upper supports 210 of the upper supporting unit 21. A display unit 4 can be mounted to the mounting unit 3, as shown in FIG. 5.

Please refer to FIG. 5, which shows the display stand 2 of the present invention in practical use. As shown, by providing the first and second bending sections 2000, 2001 on the lower supporting unit 20, the third and the fourth bending sections 2100, 2101 on the upper supporting unit 21, and the fifth and sixth bending sections 2200, 2201 on the foot rack 22, the display stand 2 has a curved configuration with increased weight load capacity, capable to support a display unit 4 up to 400 kilograms (KGs). Besides, the display stand 2 with bending tubes solves the problem of reduced structural strength due to polishing to weld seams for the conventional display mounting devices formed of welded tubes. Moreover, the display stand 2 with bending tubes possesses the advantages of significantly simplified manufacturing processes and shortened processing time.

In brief, compared to the conventional display mounting devices, the display stand of the present invention has the following advantages: (1) having a highly increased weight load capacity; (2) having an enhanced overall structural strength; and (3) greatly simplifying the manufacturing processes and reducing process time.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A high structural strength display stand with bending tubes, comprising:
a lower supporting unit having a plurality of lower supports, each of the lower supports comprising a first bending section and a second bending section, and the second bending section located at a distance from the first bending section;
an upper supporting unit having a plurality of upper supports, each of the upper supports comprising a lower end connected to an upper end of one of the lower supports, a third bending section and a fourth bending section, and the fourth bending section located at a distance from the third bending section; and
a foot rack being arranged adjacent to the lower supporting unit and assembled to the lower supports, such that the foot rack and the lower supports are juxtaposed.

2. The display stand as claimed in claim 1, wherein the foot rack comprises a plurality of supporting legs, the supporting legs and the lower supports being located side by side and assembled to one another, each of the supporting legs being formed with a fifth bending section and a sixth bending section, and the sixth bending section located at a distance from the fifth bending section.

3. The display stand as claimed in claim 2, further comprising at least one locating unit to be disposed between the foot rack and the lower supporting unit, the locating unit having two opposite sides which are correspondingly formed with a plurality of recesses configured to fitly bear against the supporting legs and the lower supports, such that the locating unit connects the foot rack to the lower supporting unit.

4. The display stand as claimed in claim 1, wherein the lower supporting unit and the upper supporting unit are selected from the group consisting of being integrally formed and being non-integrally formed.

5. The display stand as claimed in claim 1, further comprising a reinforcement unit, the reinforcement unit externally disposed in a clearance existed between the lower supports and between the upper supports at a joint of the lower supporting unit and the upper supporting unit.

6. The display stand as claimed in claim 5, further comprising at least one connection unit; the connection unit internally provided at the joint of the lower supporting unit and the upper supporting unit and located at a position corresponding to that of the reinforcement unit.

7. The display stand as claimed in claim 6, wherein the connection unit comprising an upper connection section and a lower connection section for correspondingly and respectively connected to the upper supports and the lower supports.

8. The display stand as claimed in claim 1, further comprising a table mounted to an upper end of the foot rack.

9. The display stand as claimed in claim 2, further comprising a plurality of casters separately assembled to lower ends of the lower supports of the lower supporting unit and lower ends of the supporting legs of the foot rack.

10. The display stand as claimed in claim 1, further comprising a mounting unit disposed at the upper supporting unit for a display unit to be mounted thereon.
